(19) United States
(12) Patent Application Publication
(10) Pub. No.: US 2007/0268918 A1
(43) Pub. Date: Nov. 22, 2007

(54) Packet tunneling for wireless clients using maximum transmission unit reduction

(75) Inventors: Paramesh Gopi, Cupertino, CA (US); Nafea Bishara, San Jose, CA (US)

Correspondence Address: HARNESS, DICKEY & PIERCE P.L.C., 5445 CORPORATE DRIVE, SUITE 200, TROY, MI, 48098, US

(73) Assignee: Marvell International Ltd., Hamilton HM 12 (BM)

(21) Appl. No.: 11/493,349

(22) Filed: Jul. 26, 2006

Related U.S. Application Data
(60) Provisional application No. 60/802,358, filed on May 22, 2006.

(51) Int. Cl. H04L 12/56

(52) U.S. Cl. 370/401; 370/466

(57) ABSTRACT

Apparatus having corresponding methods and computer programs comprise a first port comprising a first transmitter to transmit a first packet to a first network, wherein the first packet identifies a first maximum size; a first receiver to receive second packets from the first network, wherein each second packet has a first size less than, or equal to, the first maximum size; and a second port comprising a second transmitter to transmit third packets to a second network, wherein the second network has a second maximum size greater than the first maximum size, wherein each third packet has a second size that is less than, or equal to, the second maximum size, and wherein each third packet comprises one of the second packets and a tunneling protocol header having a size that is less than, or equal to, a difference between the first maximum size and the second maximum size.

### CROSS-REFERENCE TO RELATED APPLICATIONS

This application claims the benefit of U.S. Provisional Patent Application Ser. No. 60/802,358 filed May 22, 2006, the disclosure thereof incorporated by reference herein in its entirety.

### BACKGROUND

The present invention relates generally to data communications. More particularly, the present invention relates to packet tunneling for wireless clients using MTU (Maximum Transmission Unit) reduction.

### SUMMARY

In general, in one aspect, the invention features an apparatus comprising: a first port comprising a first transmitter to transmit a first packet to a first network, wherein the first packet identifies a first predetermined maximum packet size; a first receiver to receive second packets from the first network, wherein each of the second packets has a first packet size that is less than, or equal to, the first predetermined maximum packet size; and a second port comprising a second transmitter to transmit third packets to a second network, wherein the second network has a second predetermined maximum packet size that is greater than the first predetermined maximum packet size, wherein each of the third packets has a second packet size that is less than, or equal to, the second predetermined maximum packet size, and wherein each of the third packets comprises one of the second packets, and a tunneling protocol header having a protocol header size that is less than, or equal to, a difference between the first predetermined maximum packet size and the second predetermined maximum packet size.

Some embodiments comprise a processor to determine the first predetermined maximum packet size based on the second predetermined maximum packet size. In some embodiments, wherein the processor determines the second predetermined maximum packet size. Some embodiments comprise a processor; wherein the second port further comprises a second receiver to receive fourth packets from the second network, wherein each of the fourth packets comprises a fifth packet, and a second tunneling protocol header; wherein the processor removes the second tunneling protocol headers; and wherein the first transmitter transmits the fifth packets to the first network. In some embodiments, wherein the first network is a wireless network; and wherein the second network is a wired network. In some embodiments, the first network is compliant with at least one of the group consisting of IEEE standards 802.11, 802.11a, 802.11b, 802.11g, 802.11n, 802.16, and 802.20; and the second network is compliant with IEEE standard 802.3. In some embodiments, the tunneling protocol header comprises an address of a switch as a destination address. Some embodiments comprise the switch, wherein the switch comprises at least one third port to receive the third packets, and a processor to remove the tunneling protocol headers from the second packets, wherein the at least one third port transmits each of the second packets. Some embodiments comprise at least one client comprising a second receiver to receive the first packet, and a third transmitter to transmit one or more of the second packets. Some embodiments comprise a wireless terminal comprising the apparatus. In some embodiments, the tunneling protocol header complies with at least one protocol selected from the group consisting of: Layer 2 Tunneling Protocol (L2TP); Point-to-Point Tunneling Protocol (PPTP); Generic Routing Encapsulation (GRE); PPPoE (point-to-point protocol over Ethernet); and nested virtual local-area networks (VLANS).

In general, in one aspect, the invention features an apparatus comprising: first port means for transceiving comprising first transmitter means for transmitting a first packet to a first network, wherein the first packet identifies a first predetermined maximum packet size; first receiver means for receiving second packets from the first network, wherein each of the second packets has a first packet size that is less than, or equal to, the first predetermined maximum packet size; and second port means for transceiving comprising second transmitter means for transmitting third packets to a second network, wherein the second network has a second predetermined maximum packet size that is greater than the first predetermined maximum packet size, wherein each of the third packets has a second packet size that is less than, or equal to, the second predetermined maximum packet size, and wherein each of the third packets comprises one of the second packets, and a tunneling protocol header having a protocol header size that is less than, or equal to, a difference between the first predetermined maximum packet size and the second predetermined maximum packet size.

Some embodiments comprise processor means for determining the first predetermined maximum packet size based on the second predetermined maximum packet size. In some embodiments, the processor means determines the second predetermined maximum packet size. Some embodiments comprise means for processing; wherein the second port means further comprises second means for receiving fourth packets from the second network, wherein each of the fourth packets comprises a fifth packet, and a second tunneling protocol header; wherein the means for processing removes the second tunneling protocol headers; and wherein the first means for transmitting transmits the fifth packets to the first network. In some embodiments, the first network is a wireless network; and the second network is a wired network. In some embodiments, the first network is compliant with at least one of the group consisting of IEEE standards 802.11, 802.11a, 802.11b, 802.11g, 802.11n, 802.16, and 802.20; and the second network is compliant with IEEE standard 802.3. In some embodiments, the tunneling protocol header comprises an address of a switch as a destination address. Some embodiments comprise the switch, wherein the switch comprises at least one third port to receive the third packets, and a processor to remove the tunneling protocol headers from the second packets, wherein the at least one third port transmits each of the second packets. Some embodiments comprise at least one client comprising a second receiver to receive the first packet, and a third transmitter to transmit one or more of the second packets. Some embodiments comprise wireless terminal comprising the apparatus. In some embodiments, the tunneling protocol header complies with at least one protocol selected from the group consisting of: Layer 2 Tunneling Protocol (L2TP); Point-to-Point Tunneling Protocol (PPTP); Generic Routing Encapsulation (GRE); PPPoE (point-to-point protocol over Ethernet); and nested virtual local-area networks (VLANS).

In general, in one aspect, the invention features a method comprising: transmitting a first packet to a first network, wherein the first packet identifies a first predetermined maximum packet size; receiving second packets from the first network, wherein each of the second packets has a first packet size that is less than, or equal to, the first predetermined maximum packet size; transmitting third packets to a second network, wherein the second network has a second predetermined maximum packet size that is greater than the first predetermined maximum packet size, wherein each of the third packets has a second packet size that is less than, or equal to, the second predetermined maximum packet size, and wherein each of the third packets comprises one of the second packets, and a tunneling protocol header having a protocol header size that is less than, or equal to, a difference between the first predetermined maximum packet size and the second predetermined maximum packet size. Some embodiments comprise determining the first predetermined maximum packet size based on the second predetermined maximum packet size. Some embodiments comprise determining the second predetermined maximum packet size. Some embodiments comprise receiving fourth packets from the second network, wherein each of the fourth packets comprises a fifth packet and a second tunneling protocol header; removing the second tunneling protocol headers; and transmitting the fifth packets to the first network. In some embodiments, the first network is a wireless network; and the second network is a wired network. In some embodiments, the first network is compliant with at least one of the group consisting of IEEE standards 802.11, 802.11a, 802.11b, 802.11g, 802.11n, 802.16, and 802.20; and the second network is compliant with IEEE standard 802.3. In some embodiments, the tunneling protocol header comprises an address of a switch as a destination address. In some embodiments, the tunneling protocol header complies with at least one protocol selected from the group consisting of: Layer 2 Tunneling Protocol (L2TP); Point-to-Point Tunneling Protocol (PPTP); Generic Routing Encapsulation (GRE); PPPoE (point-to-point protocol over Ethernet); and nested virtual local-area networks (VLANS).

In general, in one aspect, the invention features a computer program comprising: causing transmission of a first packet to a first network, wherein the first packet identifies a first predetermined maximum packet size; wherein second packets are received from the first network, wherein each of the second packets has a first packet size that is less than, or equal to, the first predetermined maximum packet size; causing transmission of third packets to a second network, wherein the second network has a second predetermined maximum packet size that is greater than the first predetermined maximum packet size, wherein each of the third packets has a second packet size that is less than, or equal to, the second predetermined maximum packet size, and wherein each of the third packets comprises one of the second packets, and a tunneling protocol header having a protocol header size that is less than, or equal to, a difference between the first predetermined maximum packet size and the second predetermined maximum packet size.

Some embodiments comprise determining the first predetermined maximum packet size based on the second predetermined maximum packet size. Some embodiments comprise determining the second predetermined maximum packet size. In some embodiments, fourth packets are received from the second network, and wherein each of the fourth packets comprises a fifth packet and a second tunneling protocol header, further comprising: removing the second tunneling protocol headers; and causing transmission of the fifth packets to the first network. In some embodiments, the first network is a wireless network; and the second network is a wired network. In some embodiments, the first network is compliant with at least one of the group consisting of IEEE standards 802.11, 802.11a, 802.11b, 802.11g, 802.11n, 802.16, and 802.20; and the second network is compliant with IEEE standard 802.3. In some embodiments, the tunneling protocol header comprises an address of a switch as a destination address. In some embodiments, tunneling protocol header complies with at least one protocol selected from the group consisting of: Layer 2 Tunneling Protocol (L2TP); Point-to-Point Tunneling Protocol (PPTP); Generic Routing Encapsulation (GRE); PPPoE (point-to-point protocol over Ethernet); and nested virtual local-area networks (VLANS).

In general, in one aspect, the invention features an apparatus comprising: a receiver to receive a first packet from a network, wherein the first packet identifies a predetermined maximum packet size; and a transmitter to transmit second packets to the network, wherein each of the second packets has a packet size that is less than, or equal to, the predetermined maximum packet size.

In some embodiments, the network is a wireless network. In some embodiments, the network is compliant with at least one of the group consisting of IEEE standards 802.11, 802.11a, 802.11b, 802.11g, 802.11n, 802.16, and 802.20.

In general, in one aspect, the invention features an apparatus comprising: receiver means for receiving a first packet from a network, wherein the first packet identifies a predetermined maximum packet size; and transmitter means for transmitting second packets to the network, wherein each of the second packets has a packet size that is less than, or equal to, the predetermined maximum packet size.

In some embodiments, the network is a wireless network. In some embodiments, the network is compliant with at least one of the group consisting of IEEE standards 802.11, 802.11a, 802.11b, 802.11g, 802.11n, 802.16, and 802.20.

In general, in one aspect, the invention features a method comprising: receiving a first packet from a network, wherein the first packet identifies a predetermined maximum packet size; and transmitting second packets to the network, wherein each of the second packets has a packet size that is less than, or equal to, the predetermined maximum packet size. In some embodiments, the network is a wireless network. In some embodiments, the network is compliant with at least one of the group consisting of IEEE standards 802.11, 802.11a, 802.11b, 802.11g, 802.11n, 802.16, and 802.20.

In general, in one aspect, the invention features a computer program comprising: identifying a predetermined maximum packet size based on a first packet received from a network; and causing transmission of second packets to the network, wherein each of the second packets has a packet size that is less than, or equal to, the predetermined maximum packet size.

In some embodiments, the network is a wireless network. In some embodiments, the network is compliant with at least one of the group consisting of IEEE standards 802.11, 802.11a, 802.11b, 802.11g, 802.11n, 802.16, and 802.20.

In general, in one aspect, the invention features a packet of data comprising: a header comprising a source address in a data communication network, and a destination address of a network device in the data communication network; and a payload comprising an identifier of a MTU (Maximum Transmission Unit) to be used by the network device for the network.

The details of one or more implementations are set forth in the accompanying drawings and the description below. Other features will be apparent from the description and drawings, and from the claims.

### DESCRIPTION OF DRAWINGS

FIG. 1 shows a data communication system comprising at least one wireless client in communication with a wireless terminal over a wireless network.

FIG. 2 shows a process for handling packets generated by the wireless client in the data communication system of FIG. 1 according to a preferred embodiment of the present invention.

FIG. 3 shows an example format for a packet that identifies an MTU selected for the wireless network of FIG. 1 according to a preferred embodiment of the present invention.

FIG. 4 shows an example of a tunneling packet according to a preferred embodiment of the present invention.

FIG. 5 shows a process for handling packets addressed to the wireless client in the data communication system of FIG. 1 according to a preferred embodiment of the present invention.

FIGS. 6A-6E show various exemplary implementations of the present invention.

The leading digit(s) of each reference numeral used in this specification indicates the number of the drawing in which the reference numeral first appears.

### DETAILED DESCRIPTION

Embodiments of the present invention provide packet tunneling for wireless clients using MTU (Maximum Transmission Unit) reduction. In data communication networks comprising a wireless network that would otherwise be served by a wireless access point, it is often desirable to separate the wireless access point into two units. One of the units is a wireless terminal that communicates with the wireless clients in the wireless network. The other unit is an access switch that connects the wireless terminal with a wired network.

In some applications, it is desirable to deploy the wired network between the wireless terminal and the wireless access point. In these applications, it is necessary to exchange packets between the wireless terminal and the wireless access point over the wired network while preventing the wired network from attempting to switch the packets using the packet headers, for example so the access switch can implement security features for the wireless network. To solve this problem, embodiments of the present invention employ packet tunneling, where each packet is encapsulated in a tunneling packet having a tunneling protocol header.

However, the tunneling packet is necessarily larger that the encapsulated packet. If the size of the encapsulated packet is already at or near the MTU of the wired network, network devices in the wired network will fragment the tunneling packet. Fragmentation has several well-known disadvantages such as adversely affecting network performance. To prevent fragmentation of the tunneling packet, embodiments of the present invention reduce the MTU of the wireless network by an amount sufficient to accommodate the tunneling protocol header in the wired network without fragmentation.

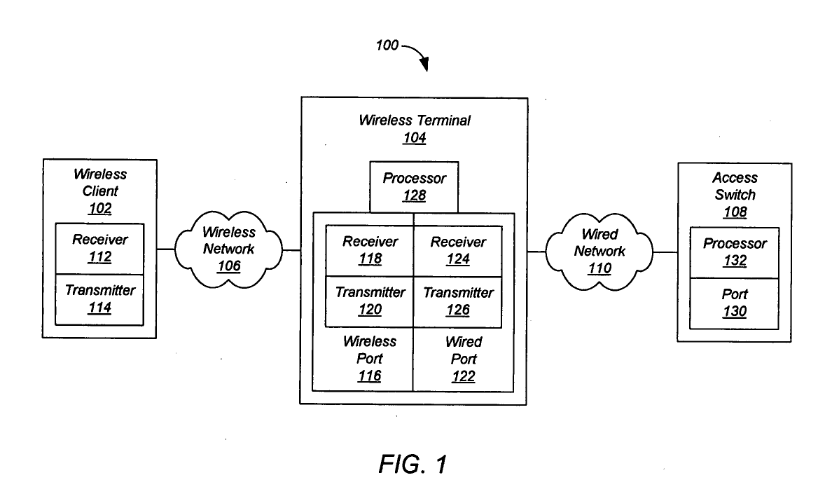

FIG. 1 shows a data communication system comprising at least one wireless client 102 in communication with a wireless terminal 104 over a wireless network 106. Wireless network 106 is preferably compliant with at least one of IEEE standards 802.11, 802.11a, 802.11b, 802.11g, 802.11n, 802.16, and 802.20. Wireless terminal 104 is in communication with an access switch 108 over a wired network 110. Wired network 110 is preferably compliant with IEEE standard 802.3.

While embodiments of the present invention are discussed in terms of a wireless network 106 and a wired network 110, embodiments of the present invention are not so limited. For example, both networks 106, 110 can be wired networks or wireless networks, or network 106 can be a wired network while network 110 can be a wireless network.

Wireless client 102 comprises a wireless receiver 112 and a wireless transmitter 114. Wireless terminal 104 comprises at least one wireless port 116 comprising a wireless receiver 118 and a wireless transmitter 120, at least one wired port 122 comprising a wired receiver 124 and a wired transmitter 126, and a processor 128. Access switch 108 comprises at least one wired port 130 and a processor 132.

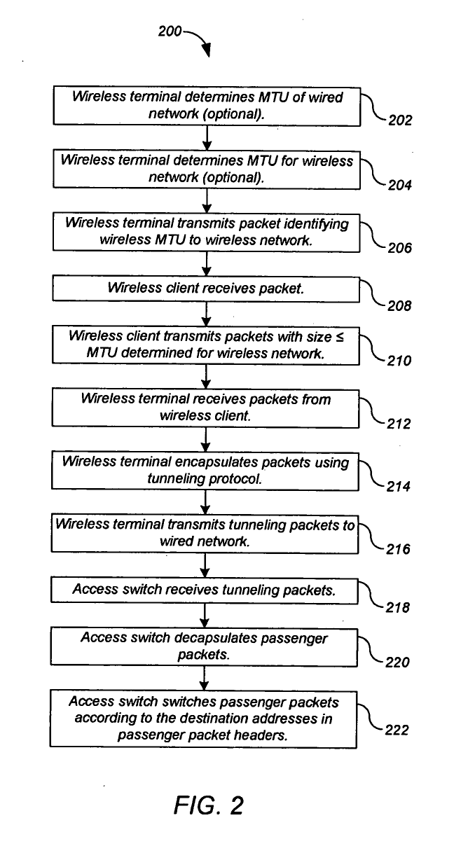

FIG. 2 shows a process 200 for handling packets generated by wireless client 102 in data communication system 100 according to a preferred embodiment of the present invention. Processor 128 of wireless terminal 104 optionally determines the MTU (also referred to herein as the “predetermined maximum packet size”) of wired network 110 (step 202). For example, wireless terminal 104 and access switch 108 perform path MTU discovery according to well-known techniques.

Once the MTU of wired network 110 is known, processor 128 of wireless terminal 104 optionally determines a MTU for wireless network 106 based on the MTU of wired network 110 (step 204). Alternatively, the MTU of wired network 110 is configured in wireless terminal 104 in advance. The MTU for wireless network 106 is selected to be less than the MTU of wired network 110 by an amount sufficient to accommodate a tunneling protocol header. Preferably the tunneling protocol header complies with a protocol such as Layer 2 Tunneling Protocol (L2TP); Point-to-Point Tunneling Protocol (PPTP); Generic Routing Encapsulation (GRE); PPPoE (point-to-point protocol over Ethernet); nested virtual local-area networks (VLANS), and the like.

For example, consider an example where wired network 110 is an Ethernet network, and the tunneling protocol is GRE. The MTU for Ethernet is 1500 octets, so an MTU of 1400 octets is selected for wireless network 106, which allows 100 octets for the GRE header.

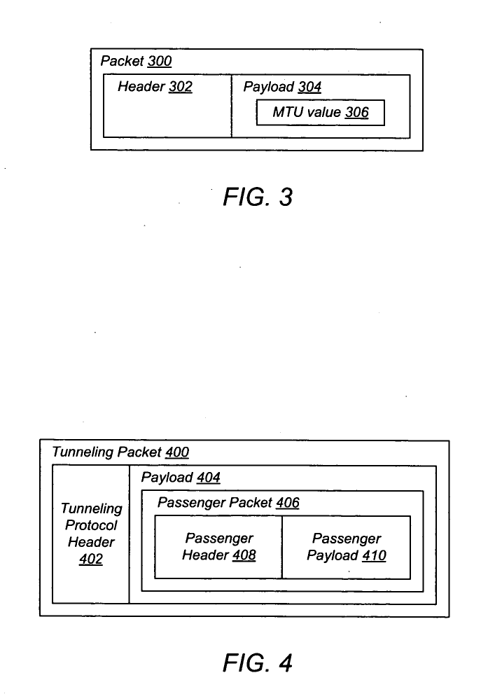

Transmitter 120 of wireless port 116 of wireless terminal 104 transmits a packet to wireless network 106 that identifies the MTU selected for wireless network 106 (step 206). FIG. 3 shows an example format for such a packet 300 according to a preferred embodiment of the present invention. Packet 300 comprises a header 302 and a payload 304. Payload 304 comprises an MTU value 306 that identifies the MTU selected for wireless network 106.

Receiver 112 of wireless client 102 receives the packet (step 208). Thereafter, transmitter 114 of wireless client 102 transmits packets to wireless network 106 that have a size that is less than, or equal to, the MTU selected for wireless network 106 (step 210).

Receiver 118 of wireless port 116 of wireless terminal 104 receives the reduced-MTU packets (also referred to herein as “passenger packets”) from wireless network 106 (step 212), and encapsulates each of the passenger packets using a tunneling protocol (step 214). FIG. 4 shows an example of the resulting tunneling packet 400 according to a preferred embodiment of the present invention. Tunneling packet 400 comprises a tunneling protocol header 402 and a payload 404 that comprises a passenger packet 406. Each tunneling protocol header 402 comprises the address of access switch 108 as a destination address.

Passenger packet 406 comprises a header 408 and a payload 410 (referred to herein as a “passenger header” and a “passenger payload,” respectively). As noted above, the MTU of wireless network 106 is selected so that the size of tunneling packet 400 is less than the MTU of wired network 110. That is, tunneling protocol header 402 has a protocol header size that is less than, or equal to, the difference between the MTU selected for wireless network 106 and the MTU of wired network 110.

Transmitter 126 of wired port 122 of wireless terminal 104 transmits tunneling packets 400 to wired network 110 (step 216). Because passenger packet 406 is encapsulated within tunneling packet 400, any switches in wired network 110 switch tunneling packet 400 based on tunneling protocol header 402, rather than based on passenger header 408.

Port 130 of access switch 108 receives tunneling packets 400 (step 218). Processor 132 of access switch 108 decapsulates the passenger packets 406 by removing the tunneling protocol headers 402 from tunneling packets 400 (step 220). Access switch 108 then switches the passenger packets 406 according to the destination addresses in the passenger headers 408 (step 222).

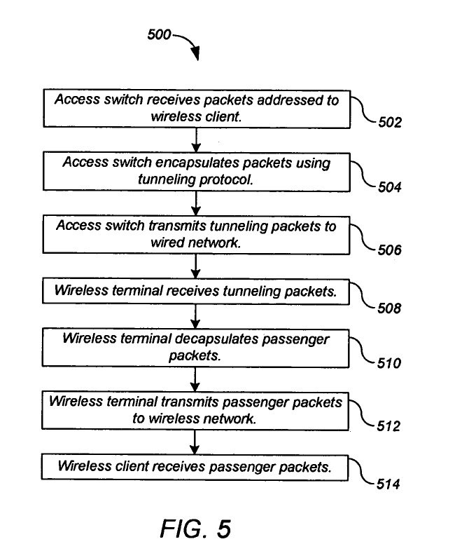

FIG. 5 shows a process 500 for handling packets addressed to wireless client 102 in data communication system 100 according to a preferred embodiment of the present invention. Access switch 108 receives packets addressed to wireless client 102 (step 502) and encapsulates the packets as passenger packets within respective tunneling packets (step 504), for example as described above with reference to FIG. 4. Each tunneling protocol header comprises the address of wireless terminal 104 as a destination address. Port 130 of access switch 108 transmits the resulting tunneling packets 400 to wired network 110 (step 506).

Receiver 124 of wired port 122 of wireless terminal 104 receives tunneling packets 400 (step 508). Processor 128 of wireless terminal 104 decapsulates the respective passenger packets 406 by removing the tunneling protocol headers 402 (step 510). Transmitter 120 of wireless port 116 of wireless terminal 104 transmits the resulting passenger packets 406 to wireless network 106 (step 512). Wireless client 102 receives passenger packets 406 (step 514).

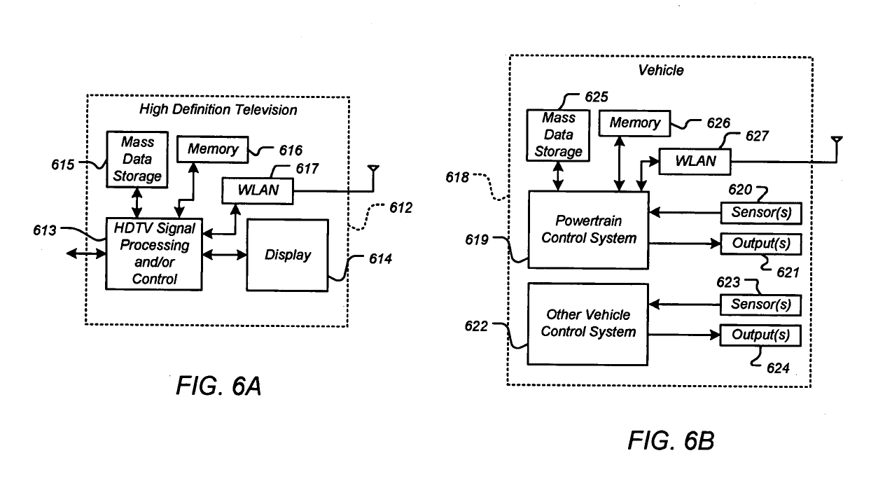

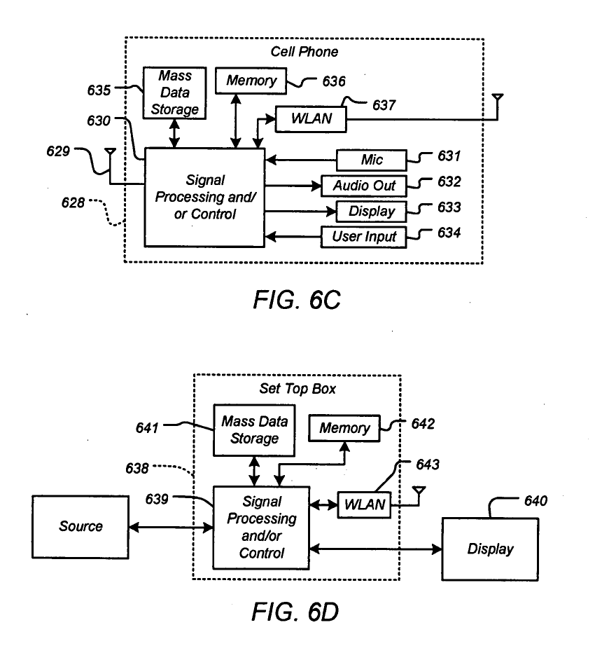

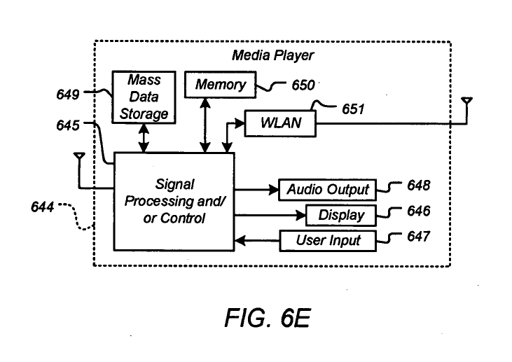

FIGS. 6A-6E show various exemplary implementations of the present invention. Referring now to FIG. 6A, the present invention can be implemented in a high definition television (HDTV) 612. The present invention may implement either or both signal processing and/or control circuits, which are generally identified in FIG. 6A at 613, a WLAN interface and/or mass data storage of the HDTV 612. The HDTV 612 receives HDTV input signals in either a wired or wireless format and generates HDTV output signals for a display 614. In some implementations, signal processing circuit and/or control circuit 613 and/or other circuits (not shown) of the HDTV 612 may process data, perform coding and/or encryption, perform calculations, format data and/or perform any other type of HDTV processing that may be required.

The HDTV 612 may communicate with mass data storage 615 that stores data in a nonvolatile manner such as optical and/or magnetic storage devices. The HDD may be a mini HDD that includes one or more platters having a diameter that is smaller than approximately 1.8″. The HDTV 612 may be connected to memory 616 such as RAM, ROM, low latency nonvolatile memory such as flash memory and/or other suitable electronic data storage. The HDTV 612 also may support connections with a WLAN via a WLAN network interface 617.

Referring now to FIG. 6B, the present invention implements a control system of a vehicle 618, a WLAN interface and/or mass data storage of the vehicle control system. In some implementations, the present invention implements a powertrain control system 619 that receives inputs from one or more sensors such as temperature sensors, pressure sensors, rotational sensors, airflow sensors and/or any other suitable sensors and/or that generates one or more output control signals such as engine operating parameters, transmission operating parameters, and/or other control signals.

The present invention may also be implemented in other control systems 622 of the vehicle 618. The control system 622 may likewise receive signals from input sensors 623 and/or output control signals to one or more output devices 624. In some implementations, the control system 622 may be part of an anti-lock braking system (ABS), a navigation system, a telematics system, a vehicle telematics system, a lane departure system, an adaptive cruise control system, a vehicle entertainment system such as a stereo, DVD, compact disc and the like. Still other implementations are contemplated.

The powertrain control system 619 may communicate with mass data storage 625 that stores data in a nonvolatile manner. The mass data storage 625 may include optical and/or magnetic storage devices for example hard disk drives HDD and/or DVDs. The HDD may be a mini HDD that includes one or more platters having a diameter that is smaller than approximately 1.8″. The powertrain control system 619 may be connected to memory 626 such as RAM, ROM, low latency non-volatile memory such as flash memory and/or other suitable electronic data storage. The powertrain control system 619 also may support connections with a WLAN via a WLAN network interface 627. The control system 622 may also include mass data storage, memory and/or a WLAN interface (all not shown).

Referring now to FIG. 6C, the present invention can be implemented in a cellular phone 628 that may include a cellular antenna 629. The present invention may implement either or both signal processing and/or control circuits, which are generally identified in FIG. 6C at 630, a WLAN interface and/or mass data storage of the cellular phone 628. In some implementations, the cellular phone 628 includes a microphone 631, an audio output 632 such as a speaker and/or audio output jack, a display 633 and/or an input device 634 such as a keypad, pointing device, voice actuation and/or other input device. The signal processing and/or control circuits 630 and/or other circuits (not shown) in the cellular phone 628 may process data, perform coding and/or encryption, perform calculations, format data and/or perform other cellular phone functions.

The cellular phone 628 may communicate with mass data storage 635 that stores data in a nonvolatile manner such as optical and/or magnetic storage devices for example hard disk drives HDD and/or DVDs. The HDD may be a mini HDD that includes one or more platters having a diameter that is smaller than approximately 1.8″. The cellular phone 628 may be connected to memory 636 such as RAM, ROM, low latency nonvolatile memory such as flash memory and/or other suitable electronic data storage. The cellular phone 628 also may support connections with a WLAN via a WLAN network interface 637.

Referring now to FIG. 6D, the present invention can be implemented in a set top box 638. The present invention may implement either or both signal processing and/or control circuits, which are generally identified in FIG. 6D at 639, a WLAN interface and/or mass data storage of the set top box 638. The set top box 638 receives signals from a source such as a broadband source and outputs standard and/or high definition audio/video signals suitable for a display 640 such as a television and/or monitor and/or other video and/or audio output devices. The signal processing and/or control circuits 639 and/or other circuits (not shown) of the set top box 638 may process data, perform coding and/or encryption, perform calculations, format data and/or perform any other set top box function.

The set top box 638 may communicate with mass data storage 643 that stores data in a nonvolatile manner. The mass data storage 643 may include optical and/or magnetic storage devices for example hard disk drives HDD and/or DVDs. The HDD may be a mini HDD that includes one or more platters having a diameter that is smaller than approximately 1.8″. The set top box 638 may be connected to memory 642 such as RAM, ROM, low latency nonvolatile memory such as flash memory and/or other suitable electronic data storage. The set top box 638 also may support connections with a WLAN via a WLAN network interface 643.

Referring now to FIG. 6E, the present invention can be implemented in a media player 644. The present invention may implement either or both signal processing and/or control circuits, which are generally identified in FIG. 6E at 645, a WLAN interface and/or mass data storage of the media player 644. In some implementations, the media player 644 includes a display 646 and/or a user input 647 such as a keypad, touchpad and the like. In some implementations, the media player 644 may employ a graphical user interface (GUI) that typically employs menus, drop down menus, icons and/or a point-and-click interface via the display 646 and/or user input 647. The media player 644 further includes an audio output 648 such as a speaker and/or audio output jack. The signal processing and/or control circuits 645 and/or other circuits (not shown) of the media player 644 may process data, perform coding and/or encryption, perform calculations, format data and/or perform any other media player function.

The media player 644 may communicate with mass data storage 649 that stores data such as compressed audio and/or video content in a nonvolatile manner. In some implementations, the compressed audio files include files that are compliant with MP3 format or other suitable compressed audio and/or video formats. The mass data storage may include optical and/or magnetic storage devices for example hard disk drives HDD and/or DVDs. The HDD may be a mini HDD that includes one or more platters having a diameter that is smaller than approximately 1.8″. The media player 644 may be connected to memory 650 such as RAM, ROM, low latency nonvolatile memory such as flash memory and/or other suitable electronic data storage. The media player 644 also may support connections with a WLAN via a WLAN network interface 651. Still other implementations in addition to those described above are contemplated.

Embodiments of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the invention have been described. Nevertheless, it will be understood that various modifications may be made without departing from the spirit and scope of the invention. Accordingly, other implementations are within the scope of the following claims.

What is claimed is:

1. An apparatus comprising:
a first port comprising
a first transmitter to transmit a first packet to a first network, wherein the first packet identifies a first predetermined maximum packet size;
a first receiver to receive second packets from the first network, wherein each of the second packets has a first packet size that is less than, or equal to, the first predetermined maximum packet size; and
a second port comprising
a second transmitter to transmit third packets to a second network, wherein the second network has a second predetermined maximum packet size that is greater than the first predetermined maximum packet size, wherein each of the third packets has a second packet size that is less than, or equal to, the second predetermined maximum packet size, and wherein each of the third packets comprises
one of the second packets, and
a tunneling protocol header having a protocol header size that is less than, or equal to, a difference between the first predetermined maximum packet size and the second predetermined maximum packet size.

2. The apparatus of claim 1, further comprising:
a processor to determine the first predetermined maximum packet size based on the second predetermined maximum packet size.

3. The apparatus of claim 2:
wherein the processor determines the second predetermined maximum packet size.

4. The apparatus of claim 1, further comprising:
a processor;
wherein the second port further comprises a second receiver to receive fourth packets from the second network, wherein each of the fourth packets comprises
a fifth packet, and
a second tunneling protocol header;
wherein the processor removes the second tunneling protocol headers; and
wherein the first transmitter transmits the fifth packets to the first network.

5. The apparatus of claim 1:
wherein the first network is a wireless network; and
wherein the second network is a wired network.

6. The apparatus of claim 1:
wherein the first network is compliant with at least one of the group consisting of IEEE standards 802.11, 802.11a, 802.11b, 802.11g, 802.11n, 802.16, and 802.20; and
wherein the second network is compliant with IEEE standard 802.3.

7. The apparatus of claim 1:
wherein the tunneling protocol header comprises an address of a switch as a destination address.

8. The apparatus of claim 7, further comprising:
the switch, wherein the switch comprises
at least one third port to receive the third packets, and
a processor to remove the tunneling protocol headers from the second packets,
wherein the at least one third port transmits each of the second packets.

9. The apparatus of claim 1, further comprising:
at least one client comprising
a second receiver to receive the first packet, and
a third transmitter to transmit one or more of the second packets.

10. A wireless terminal comprising the apparatus of claim 1.

11. The apparatus of claim 1, wherein the tunneling protocol header complies with at least one protocol selected from the group consisting of:
Layer 2 Tunneling Protocol (L2TP);
Point-to-Point Tunneling Protocol (PPTP);
Generic Routing Encapsulation (GRE);
PPPoE (point-to-point protocol over Ethernet); and
nested virtual local-area networks (VLANS).

12. An apparatus comprising:
first port means for transceiving comprising
first transmitter means for transmitting a first packet to a first network, wherein the first packet identifies a first predetermined maximum packet size;
first receiver means for receiving second packets from the first network, wherein each of the second packets has a first packet size that is less than, or equal to, the first predetermined maximum packet size; and
second port means for transceiving comprising
second transmitter means for transmitting third packets to a second network, wherein the second network has a second predetermined maximum packet size that is greater than the first predetermined maximum packet size, wherein each of the third packets has a second packet size that is less than, or equal to, the second predetermined maximum packet size, and wherein each of the third packets comprises
one of the second packets, and
a tunneling protocol header having a protocol header size that is less than, or equal to, a difference between the first predetermined maximum packet size and the second predetermined maximum packet size.

13. The apparatus of claim 12, further comprising:
processor means for determining the first predetermined maximum packet size based on the second predetermined maximum packet size.

14. The apparatus of claim 13:
wherein the processor means determines the second predetermined maximum packet size.

15. The apparatus of claim 12, further comprising:
means for processing;
wherein the second port means further comprises second means for receiving fourth packets from the second network, wherein each of the fourth packets comprises
a fifth packet, and
a second tunneling protocol header;
wherein the means for processing removes the second tunneling protocol headers; and
wherein the first means for transmitting transmits the fifth packets to the first network.

16. The apparatus of claim 12:
wherein the first network is a wireless network; and
wherein the second network is a wired network.

17. The apparatus of claim 12:
wherein the first network is compliant with at least one of the group consisting of IEEE standards 802.11, 802.11a, 802.11b, 802.11g, 802.11n, 802.16, and 802.20; and
wherein the second network is compliant with IEEE standard 802.3.

18. The apparatus of claim 12:
wherein the tunneling protocol header comprises an address of a switch as a destination address.

19. The apparatus of claim 18, further comprising:
the switch, wherein the switch comprises
at least one third port to receive the third packets, and
a processor to remove the tunneling protocol headers from the second packets,
wherein the at least one third port transmits each of the second packets.

20. The apparatus of claim 12, further comprising:
at least one client comprising
a second receiver to receive the first packet, and
a third transmitter to transmit one or more of the second packets.

21. A wireless terminal comprising the apparatus of claim 12.

22. The apparatus of claim 12, wherein the tunneling protocol header complies with at least one protocol selected from the group consisting of:
Layer 2 Tunneling Protocol (L2TP);
Point-to-Point Tunneling Protocol (PPTP);
Generic Routing Encapsulation (GRE);
PPPoE (point-to-point protocol over Ethernet); and
nested virtual local-area networks (VLANS).

23. A method comprising:
transmitting a first packet to a first network, wherein the first packet identifies a first predetermined maximum packet size;
receiving second packets from the first network, wherein each of the second packets has a first packet size that is less than, or equal to, the first predetermined maximum packet size;
transmitting third packets to a second network, wherein the second network has a second predetermined maximum packet size that is greater than the first predetermined maximum packet size, wherein each of the third packets has a second packet size that is less than, or equal to, the second predetermined maximum packet size, and wherein each of the third packets comprises
one of the second packets, and
a tunneling protocol header having a protocol header size that is less than, or equal to, a difference between the first predetermined maximum packet size and the second predetermined maximum packet size.

24. The method of claim 23, further comprising:
determining the first predetermined maximum packet size based on the second predetermined maximum packet size.

25. The method of claim 24, further comprising:
determining the second predetermined maximum packet size.

26. The method of claim 23, further comprising:
receiving fourth packets from the second network, wherein each of the fourth packets comprises a fifth packet and a second tunneling protocol header;
removing the second tunneling protocol headers; and
transmitting the fifth packets to the first network.

27. The method of claim 23:
wherein the first network is a wireless network; and
wherein the second network is a wired network.

28. The method of claim 23:
wherein the first network is compliant with at least one of the group consisting of IEEE standards 802.11, 802.11a, 802.11b, 802.11g, 802.11n, 802.16, and 802.20; and
wherein the second network is compliant with IEEE standard 802.3.

29. The method of claim 23:
wherein the tunneling protocol header comprises an address of a switch as a destination address.

30. The method of claim 23, wherein the tunneling protocol header complies with at least one protocol selected from the group consisting of:
Layer 2 Tunneling Protocol (L2TP);
Point-to-Point Tunneling Protocol (PPTP);
Generic Routing Encapsulation (GRE);
PPPoE (point-to-point protocol over Ethernet); and
nested virtual local-area networks (VLANS).

31. A computer program comprising:
causing transmission of a first packet to a first network, wherein the first packet identifies a first predetermined maximum packet size;
wherein second packets are received from the first network, wherein each of the second packets has a first packet size that is less than, or equal to, the first predetermined maximum packet size;
causing transmission of third packets to a second network, wherein the second network has a second predetermined maximum packet size that is greater than the first predetermined maximum packet size, wherein each of the third packets has a second packet size that is less than, or equal to, the second predetermined maximum packet size, and wherein each of the third packets comprises
one of the second packets, and
a tunneling protocol header having a protocol header size that is less than, or equal to, a difference between the first predetermined maximum packet size and the second predetermined maximum packet size.

32. The computer program of claim 31, further comprising:
determining the first predetermined maximum packet size based on the second predetermined maximum packet size.

33. The computer program of claim 32, further comprising:
determining the second predetermined maximum packet size.

34. The computer program of claim 31, wherein fourth packets are received from the second network, and wherein each of the fourth packets comprises a fifth packet and a second tunneling protocol header, further comprising:
removing the second tunneling protocol headers; and
causing transmission of the fifth packets to the first network.

35. The computer program of claim 31:
wherein the first network is a wireless network; and
wherein the second network is a wired network.

36. The computer program of claim 31:
wherein the first network is compliant with at least one of the group consisting of IEEE standards 802.11, 802.11a, 802.11b, 802.11g, 802.11n, 802.16, and 802.20; and
wherein the second network is compliant with IEEE standard 802.3.

37. The computer program of claim 31:
wherein the tunneling protocol header comprises an address of a switch as a destination address.

38. The computer program of claim 31, wherein the tunneling protocol header complies with at least one protocol selected from the group consisting of:
Layer 2 Tunneling Protocol (L2TP);
Point-to-Point Tunneling Protocol (PPTP);
Generic Routing Encapsulation (GRE);
PPPoE (point-to-point protocol over Ethernet); and
nested virtual local-area networks (VLANS).

39. An apparatus comprising:
a receiver to receive a first packet from a network, wherein the first packet identifies a predetermined maximum packet size; and
a transmitter to transmit second packets to the network, wherein each of the second packets has a packet size that is less than, or equal to, the predetermined maximum packet size.

40. The apparatus of claim 39:
wherein the network is a wireless network.

41. The apparatus of claim 39:
wherein the network is compliant with at least one of the group consisting of IEEE standards 802.11, 802.11a, 802.11b, 802.11g, 802.11n, 802.16, and 802.20.

42. An apparatus comprising:
receiver means for receiving a first packet from a network, wherein the first packet identifies a predetermined maximum packet size; and
transmitter means for transmitting second packets to the network, wherein each of the second packets has a packet size that is less than, or equal to, the predetermined maximum packet size.

43. The apparatus of claim 42:
wherein the network is a wireless network.

44. The apparatus of claim 42:
wherein the network is compliant with at least one of the group consisting of IEEE standards 802.11, 802.11a, 802.11b, 802.11g, 802.11n, 802.16, and 802.20.

45. A method comprising:
receiving a first packet from a network, wherein the first packet identifies a predetermined maximum packet size; and
transmitting second packets to the network, wherein each of the second packets has a packet size that is less than, or equal to, the predetermined maximum packet size.

46. The method of claim 45:
wherein the network is a wireless network.

47. The method of claim 45:
wherein the network is compliant with at least one of the group consisting of IEEE standards 802.11, 802.11a, 802.11b, 802.11g, 802.11n, 802.16, and 802.20.

48. A computer program comprising:
identifying a predetermined maximum packet size based on a first packet received from a network; and
causing transmission of second packets to the network, wherein each of the second packets has a packet size that is less than, or equal to, the predetermined maximum packet size.

49. The computer program of claim 48:
wherein the network is a wireless network.

50. The computer program of claim 48:
wherein the network is compliant with at least one of the group consisting of IEEE standards 802.11, 802.11a, 802.11b, 802.11g, 802.11n, 802.16, and 802.20.

51. A packet of data comprising:
a header comprising
a source address in a data communication network, and
a destination address of a network device in the data communication network; and
a payload comprising an identifier of a MTU (Maximum Transmission Unit) to be used by the network device for the network.
